(19) United States
(12) Patent Application Publication
(10) Pub. No.: US 2005/0109904 A1
(43) Pub. Date: May 26, 2005

(54) Devices and methods for preventing damage to wire

(76) Inventors: Frederick James Diggle III, Birmingham, AL (US); Steven Ryals, Pinson, AL (US)

Correspondence Address: KIRKPATRICK & LOCKHART NICHOLSON GRAHAM LLP, 535 SMITHFIELD STREET, PITTSBURGH, PA, 15222, US

(21) Appl. No.: 10/723,113

(22) Filed: Nov. 26, 2003

(51) Int. Cl. F16B 45/00

(52) U.S. Cl. 248/304

(57) ABSTRACT

A device for preventing damage to a wire. The device includes a first curved end for connecting the device to a supporting structure. The device also contains a second curved end for supporting at least one skein of the wire on the device.

### BACKGROUND

The present invention, in various embodiments, relates generally to devices, methods and systems for preventing damage to cable or wire such as, for example, voice or data wire.

Cable or wire is often installed inside raceway or conduit structures such as walls and ceilings. Sometimes, when cable or wire is pulled through a span within a raceway or a conduit structure, it is not pulled through the entire span at one time. Instead it is first pulled from a beginning point to an opening in the raceway or conduit structure at an intermediate point. Excess cable or wire is pulled through the opening in the raceway or conduit structure. The cable or wire is then pulled back through the opening at the intermediate point, through the raceway or conduit structure to a next intermediate point along the span or to a termination point. Excess cable or wire at the intermediate point or points is often placed on the floor.

Sometimes, when cable or wire is placed on the floor, those present may step on it. Stepping on cable or wire is especially common on large job sites where many workers in different trades are present. Cable or wire can be damaged when it is stepped on. Many types of cable or wire are made up of combinations of smaller strands of wire. The smaller strands are often twisted together in a series of twisted pairs. These twisted pairs help to minimize interference between the signals in each individual strand. Twisted pairs are often separated in a cable or wire only by a narrow wall made of plastic or another insulating material. When the cable or wire is stepped on, the walls between the twisted pairs may break. Also, the twisted pairs may become untwisted. Either of these events may increase the interference between the signals in the individual strands. Increased interference between the strands may cause signals to be degraded or lost in the affected cable or wire.

### SUMMARY

The present invention, in various embodiments, is directed to a device for preventing damage to a wire. The device has a first curved end for connecting the device to a supporting structure. The device also has a second curved end for supporting at least one skein of the wire on the device.

The present invention, in various embodiments, is directed to a method for preventing damage to a wire. The method includes pulling the wire through a portion of a span within a conduit structure to an intermediate point. The method also includes hanging excess of the wire at the intermediate point on a skein holding device. The skein holding device has a first curved end for connecting the skein holding device to a supporting structure and a second curved end for supporting at least one skein of wire on the skein holding device. The method also includes pulling the wire through another portion of a span within the conduit structure to a termination point.

Other systems, methods, and/or products according to embodiments will be or become apparent to one with skill in the art upon review of the following drawings and detailed description. It is intended that all such additional systems, methods, and/or products be included within this description, be within the scope of the present invention, and be protected by the accompanying claims.

### BRIEF DESCRIPTION OF THE DRAWINGS

Further advantages of the present invention may be better understood by referring to the following description taken in conjunction with the accompanying drawings, in which:

FIG. 1A is a side-view drawing of a skein holding device according to various embodiments;

FIG. 1B is a top-view drawing of a skein holding device according to various embodiments;

FIG. 2A is a side-view drawing of a skein holding device with a hinged portion according to various embodiments;

FIG. 2B is a top-view drawing of a skein holding device with a hinged portion according to various embodiments;

FIG. 3A is a drawing of a skein holding device attached to a ladder and holding a skein of cable or wire according to various embodiments;

FIG. 3B is a drawing of a skein holding device attached to a ladder and holding a skein of cable or wire according to various embodiments;

FIG. 4A is a drawing of a skein holding device attached to a ladder and holding a skein of cable or wire according to various embodiments;

FIG. 4B is a drawing of a skein holding device attached to a ladder and holding a skein of cable or wire according to various embodiments;

FIG. 5 is a drawing of a skein holding device attached to a ceiling and holding a skein of cable or wire according to various embodiments;

FIG. 6A is a drawing of a system for preventing damage to cable or wire according to various embodiments;

FIG. 6B is a drawing of a system for preventing damage to cable or wire according to various embodiments; and

FIG. 7 is a flowchart illustrating a method for preventing damage to cable or wire according to various embodiments.

### DESCRIPTION

It is to be understood that the figures and descriptions of the present invention have been simplified to illustrate elements that are relevant for a clear understanding of the present invention, while eliminating, for purposes of clarity, other elements such as, for example, various manufacturing details and components. Those of ordinary skill in the art will recognize that these and other elements may be desirable. However, because such elements are well known in the art, and because they do not facilitate a better understanding of the present invention, a discussion of such elements is not provided herein.

The term “supporting structure” as used herein refers generally to any structure to which a skein holding device could be secured. “Supporting structures” include, for example, ladders, ceiling components, wall components, etc. The term “conduit structure” as used herein refers generally to raceway or other structures through which a span of cable or wire may be run. “Conduit structures” include, for example, ceilings, walls, ceiling beams, etc.

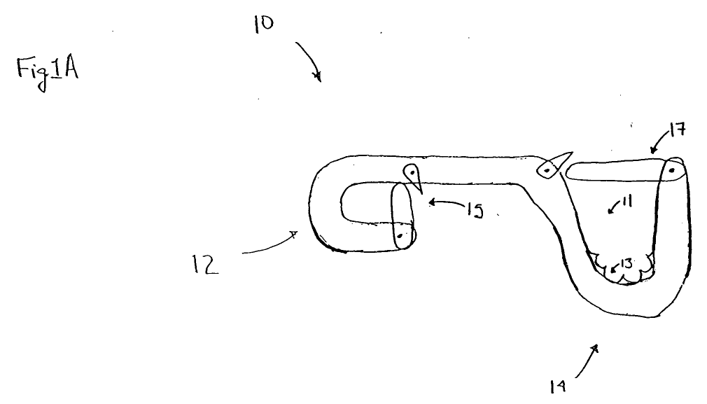

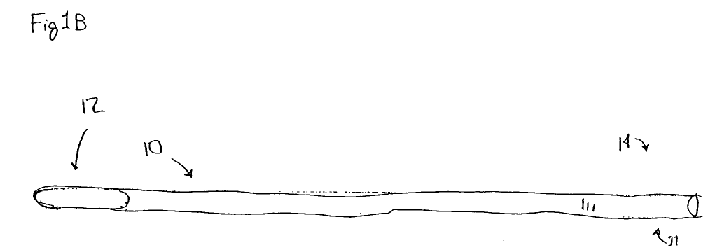

FIG. 1A illustrates a side-view of a skein holding device 10 according to various embodiments of the present invention. FIG. 1B illustrates a top-view of the skein holding device 10 according to various embodiments. The skein holding device 10 may have a mounting end 12 and a hanging end 14. The hanging end 14 may have an inside surface 11. According to various embodiments, the skein holding device 10 is made of hard rubber, plastic, or aluminum. Also according to various embodiments, the skein holding device 10 is partially or totally covered with a coating such as a rubber coating.

In various embodiments, the mounting end 12 of the skein holding device 10 has a narrow hook shape for mounting the skein holding device 10 on, for example, a narrow orifice. In other embodiments, the mounting end 12 of the skein holding device 10 has a wide hook shape for mounting the skein holding device 10 on, for example, a larger orifice. According to various embodiments, the mounting end 12 also includes a clamp or latch (not shown).

The hanging end 14 of the skein holding device 10 has, in various embodiments, a wide hook shape. A wide hook shape on the hanging end 14 can, for example, allow the hanging end 14 to accommodate large quantities of cable or wire, or quantities of cable or wire that are thick. In another embodiment, the hanging end 14 of the skein holding device 10 has a narrow hook shape. A narrow hook shape on the hanging end 14 can, for example, allow the hanging end 14 to accommodate small quantities of cable or wire, or wire that is thin. According to various embodiments, the hanging end 14 of the skein holding device 10 has grooves (not shown) along its inside surface 11. The grooves, in various embodiments, are roughly the same diameter as the cable or wire to be held by the skein holding device 10. The grooves can, for example, help to prevent cable or wire from slipping out of the hanging end 14. According to various embodiments, the hanging end 14 has a clamp or latch (not shown). A clamp or latch on the hanging end 14 can, for example, help to secure cable or wire to the hanging end 14.

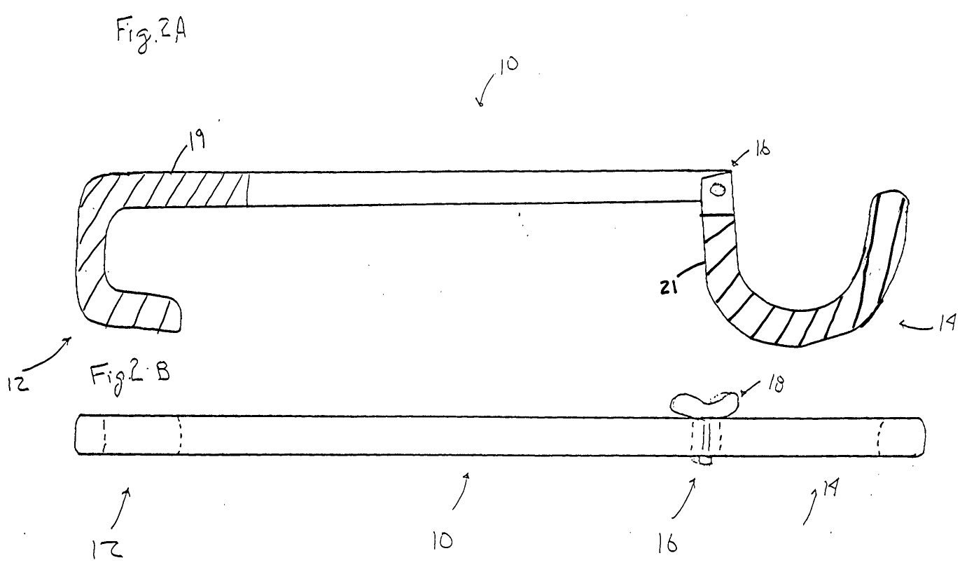

FIGS. 2A and 2B illustrate a side-view and a top-view, respectively, of a skein holding device 10 according to various embodiments of the present invention. In various embodiments, the hanging end 14 of the skein holding device 10 is attached at a hinge 16 and secured by a fastener such as, for example, a nut and thumbscrew 18.

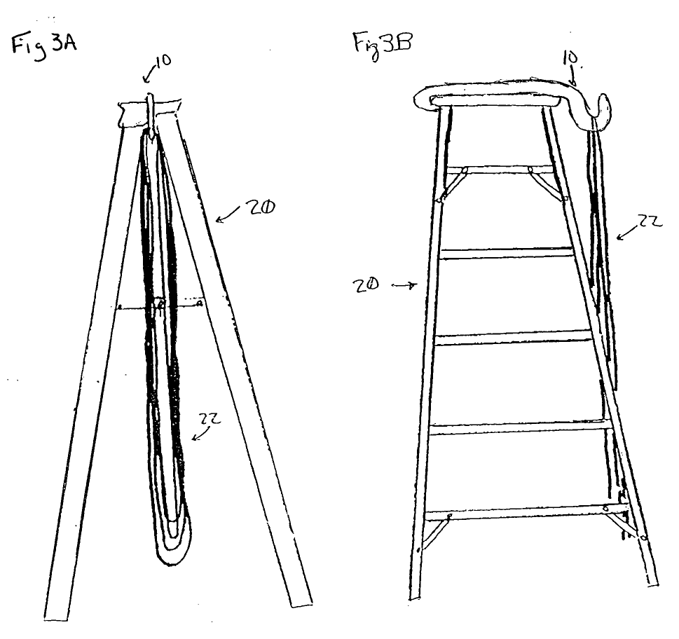

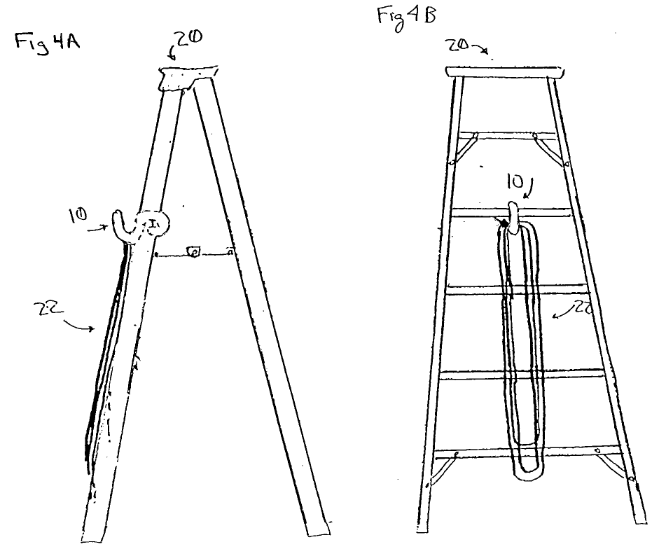

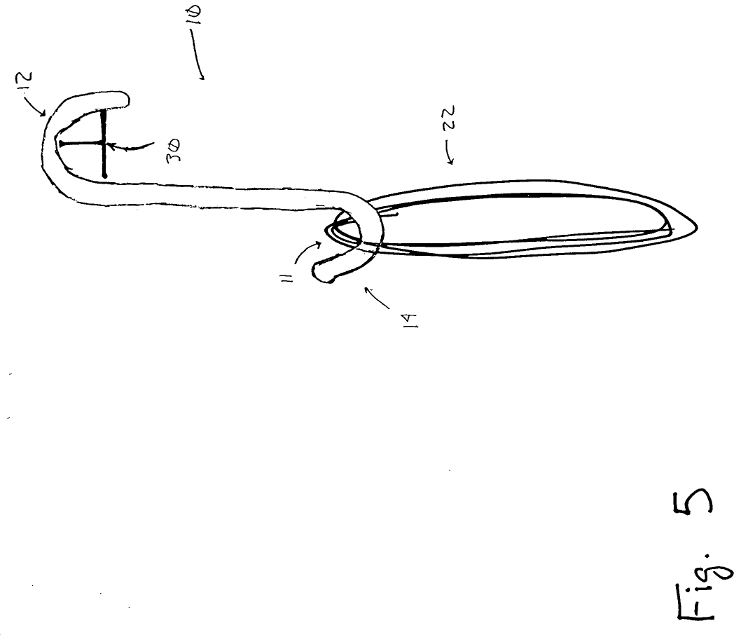

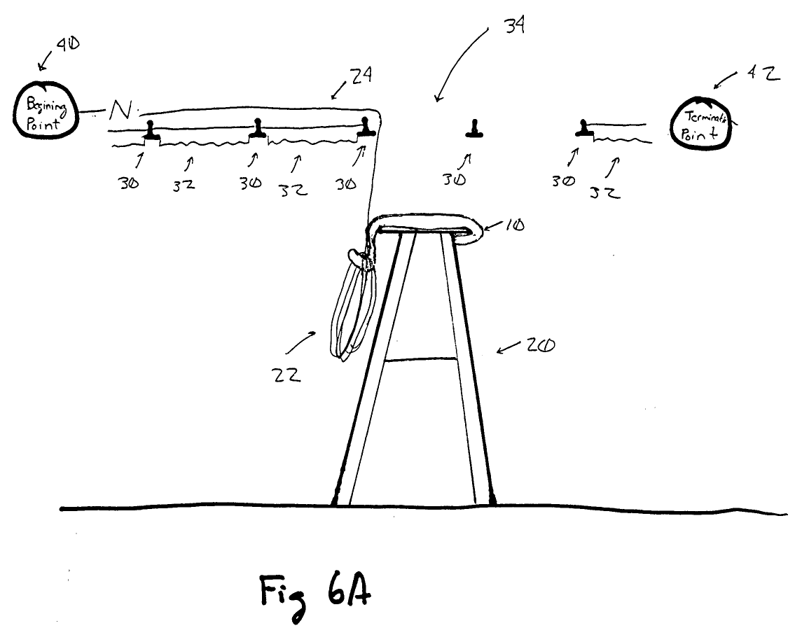

FIGS. 3A, 3B, 4A, 4B, and 5 show various skein holding devices 10 mounted to supporting structures according to various embodiments. In various embodiments, the mounting end 12 of the skein holding device 10 is fastened to the top of a ladder 20 as illustrated in FIGS. 3A and 3B. In various embodiments, the mounting end 12 of the skein holding device 10 is fastened to a rung of a ladder 20 as illustrated in FIGS. 4A and 4B. In various embodiments, the mounting end 12 of the skein holding device 10 is hung over a drop ceiling tee support 30, or ceiling beam as illustrated in FIG. 5. In various embodiments, the mounting end 12 of the skein holding device 14 may be hung from a beam or other component of a wall or ceiling.

In various embodiments, the mounting end 12 of the skein holding device 10 can be secured to various supporting structures by additional means. For example, in various embodiments, the mounting end 12 has a coating such as a rubber coating to increase friction between the skein holding device 10 and the supporting structure. Also, in various embodiments, a clamp or latch (not shown) is present on the mounting end 12 as described hereinabove. A clamp or latch can further secure the skein holding device 10 to the supporting structure.

According to various embodiments, the hanging end 14 of the skein holding device 10 is used to hang cable or wire from the skein holding device 10 as shown, for example, in FIGS. 3A, 3B, 4A, 4B, and 5. Cable or wire may be secured to the hanging end 14 in a variety of ways. For example, gravity can be used to keep the cable or wire in place as illustrated in FIGS. 3A, 3B, 4A, 4B, and 5. In various embodiments, a rubber coating over the hanging end 14 increases friction between the cable or wire and the hanging end 14. In various embodiments, grooves (not shown) on the inside surface 11 of the hanging end 14, as described hereinabove, increase friction between the cable or wire and the hanging end 14. Increased friction between the cable or wire and the hanging end 14 makes it more difficult for the cable or wire to slip out of the hanging end 14. Also, in various embodiments, a clamp or latch (not shown) on the hanging end 14, as described herein above, may prevent cable or wire from slipping out of the hanging end 14.

According to various embodiments, the same skein holding device 10 may be adapted to mount to various supporting structures, including for example a ladder, a ceiling beam, and a wall beam. In various embodiments, the same skein holding device 10 may be adapted for holding cable or wire while mounted to supporting structures that cause the hanging end to be oriented at different angles. This may be accomplished by pivoting the hanging end 14 at a hinge 16 as shown, for example, in FIGS. 2A and 2B.

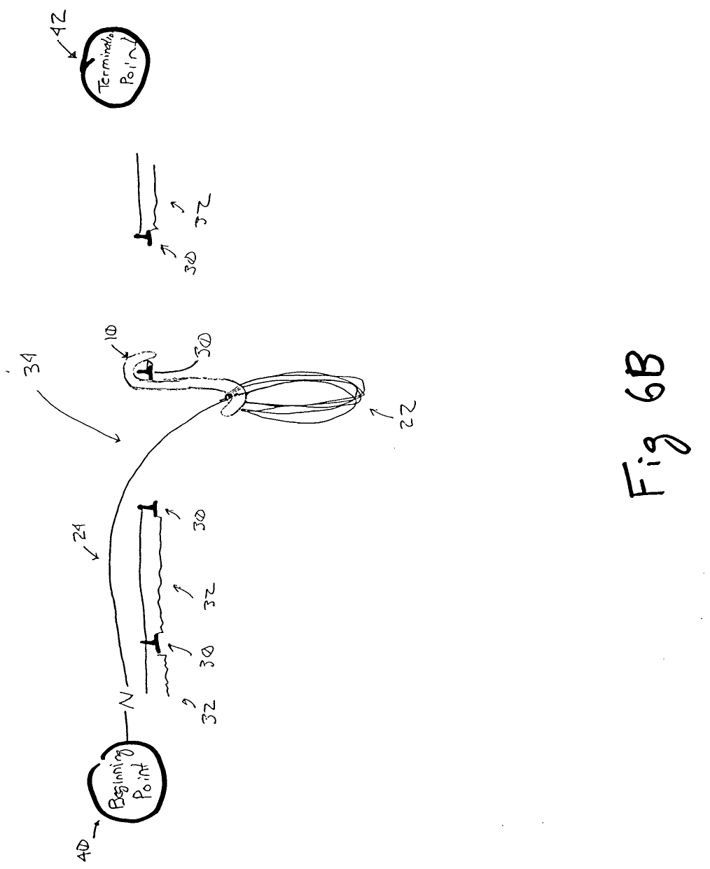

FIGS. 6A and 6B show systems according to various embodiments of the present invention. In various embodiments, a span of wire 24 begins at a beginning point 40. In various embodiments, the beginning point 40 is a piece of equipment, such as for example a network hub, a call center, a breaker box, a telephone, or a personal computer. In various embodiments, the span of wire ends at a termination point 42. According to various embodiments, the termination point 42 is another piece of equipment, such as for example, a network hub, a call center, a breaker box, a telephone, or a personal computer. In various embodiments, the raceway or conduit structure that the wire 24 spans is a drop ceiling as shown in FIGS. 6A and 6B by drop ceiling tee supports 30 and drop ceiling panels 32. In various embodiments, the cable or wire is pulled through other raceway or conduit structures such as, for example, ceiling beams, and walls.

According to various embodiments, the system includes a ladder 20. The skein holding device 10 can be fastened to the ladder as shown in FIG. 6A. In another embodiment, the skein holding device 10 is fastened to one of the tee supports 30 as shown in FIG. 6B, or to another supporting structure. In various embodiments, wire 24 is run from the beginning point 40 to the intermediate point 34. At the intermediate point 34, the wire 24 is consolidated into a skein 22. According to various embodiments, the skeins 22 are hung from the skein holding device 10 to prevent the skeins 22 from resting on the ground.

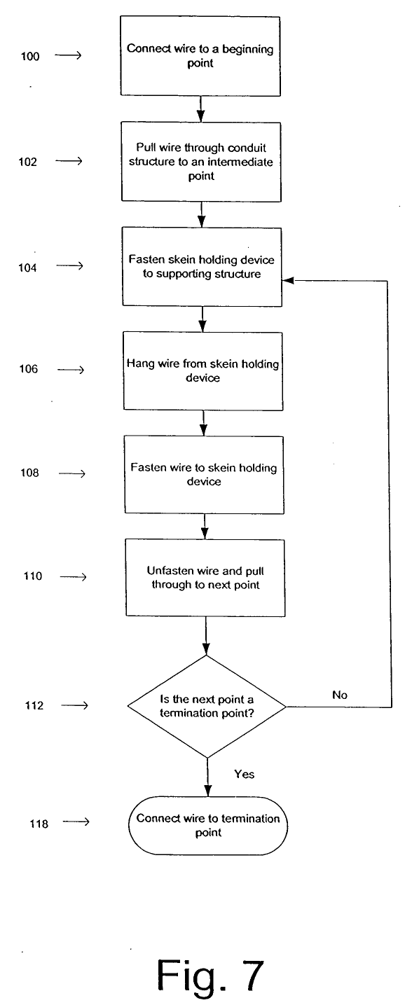

FIG. 7 illustrates a method of preventing damage to wire according to various embodiments of the present invention. At step 100, according to various embodiments, the wire 24 is functionally connected to a beginning point 40. In various embodiments, the wire is pulled through a raceway or conduit structure to a first intermediate point 34 at step 102. The raceway or conduit structure can be, for example, a ceiling beam, a wall, or another conduit. In various embodiments, the raceway or conduit structure is a drop ceiling. According to various embodiments, one or more drop ceiling panels 32 are removed from the drop ceiling to create the intermediate point 34. In various embodiments, the wire 24 may be dropped between two tee supports 30 at intermediate point 34 and consolidated into a skein 22.

At step 104, a skein holding device 10 is fastened to a supporting structure. According to various embodiments, the skein holding device 10 is fastened to a ladder 20 as shown in FIG. 6A. According to another embodiment, the skein holding device 10 is fastened to a tee support 30 as shown in FIG. 6B. In various embodiments, the skein holding device 10 is fastened to another supporting structure. According to various embodiments, the skein of wire 22 is hung from the skein holding device 10 at step 106. The skein 22 may be connected and fastened to the skein holding device 10 at step 108. According to various embodiments, the skein 22 is held in place by a variety of methods including, for example, a latch or clamp as described herein above. While the skein 22 is fastened to the skein holding device 10, various tasks may take place including, for example, fastening the wire 24 along the existing span and connecting the wire 24 to various pieces of equipment.

In various embodiments, the skein 22 is removed from the skein holding device 10 and pulled through the raceway or conduit structure to a next point at step 110. The next point may be another intermediate point 34, or a termination point 42. At step 112, if the next point is another intermediate point, the method returns to step 104. Then, the processes of steps 104-112 may be repeated. If at step 112 the next point is a termination point, then the process may proceed to step 118. At step 118, the wire 24 may be functionally connected to the termination point 42.

While several embodiments of the invention have been described, it should be apparent that various modifications, alterations and adaptations to those embodiments may occur to persons skilled in the art with the attainment of some or all of the advantages of the present invention. It is therefore intended to cover all such modifications, alterations and adaptations without departing from the scope and spirit of the present invention as defined by the appended claims.

1. A device for preventing damage to a wire having a given diameter, the device comprising:
a first curved end for connecting the device to a supporting structure, wherein the first curved end fits over at least a portion of the supporting structure; and
a second curved end for supporting at least one skein of the wire on the device, wherein the second curved end comprises a curved inside surfaces wherein the curved inside surface defines a plurality of grooves, and wherein at least one of the grooves has a diameter approximately the same as the diameter of the wire.

2. The device of claim 1, wherein the supporting structure is a ladder.

3. The device of claim 1, wherein the supporting structure is a ceiling component.

4. The device of claim 1, wherein the device is made from a material selected from the group consisting of rubber, plastic, and aluminum.

5. The device of claim 1, wherein a portion of the device is coated with a soft material.

6. The device of claim 5, wherein the soft material is rubber.

7. (canceled)

8. The device of claim 1, wherein the curved end has a small diameter.

9. The device of claim 1, wherein the first curved end further comprises a fastening device.

10. The device of claim 9, wherein the fastening device is selected from the group consisting of a clamp and a latch.

11. The device of claim 1, wherein the second curved end is hook shaped.

12. The device of claim 11, wherein the hook shape has a large diameter.

13. The device of claim 1, wherein the second curved end is coated with a soft material.

14. The device of claim 1, wherein each of the plurality of grooves has a diameter approximately the same as the diameter of the wire.

15. (canceled)

16. (canceled)

17. The device of claim 1, wherein the first curved end pivots at a hinge.

18. The device of claim 1, wherein the second curved end pivots at a hinge.

19. (canceled)

20. The device of claim 1, further comprising means for changing the shape of the device, wherein the means for changing of the shape of the device is for connecting the device to supporting structures at different angles.

21. A method for preventing damage to a wire, the method comprising:
pulling the wire through a portion of a span within a conduit structure to an intermediate point;
hanging excess of the wire at the intermediate point on a skein holding device, wherein the skein holding device comprises a first curved end for connecting the skein holding device to a supporting structure and a second curved end for supporting at least one skein of the wire on the skein holding device; and
pulling the wire through another portion of the span to a termination point.

22. The method of claim 21, further comprising fastening the skein holding device to a supporting structure.

23. The method of claim 22, wherein the fastening includes securing the skein holding device to the supporting structure with a latch.

24. The method of claim 21, wherein the supporting structure is chosen from the group consisting of a ceiling and a wall.

25. The method of claim 21, further comprising fastening the wire to the skein holding device.

26. The method of claim 25, wherein the fastening is done with a latch.

27. The method of claim 21, further comprising:
connecting the wire to a beginning point; and
connecting the wire to a termination point.
